(19) United States
(12) Patent Application Publication
(10) Pub. No.: US 2022/0400688 A1
(43) Pub. Date: Dec. 22, 2022

(54) Method for Oxygen Regenerating a Facial Mask

(71) Applicant: Serville Waterman, Brooklyn, NY (US)

(72) Inventor: Serville Waterman, Brooklyn, NY (US)

(21) Appl. No.: 17/381,560

(22) Filed: Jul. 21, 2021

Related U.S. Application Data
(63) Continuation-in-part of application No. 17/354,372, filed on Jun. 22, 2021.

(51) Int. Cl. A01N 65/20; A41D 13/11; D06B 1/02

(52) U.S. Cl. CPC A01N 65/20; A41D 13/1192; D06B 1/02

(57) ABSTRACT

A method for oxygen regenerating of a facial mask is disclosed: providing sterile containers; providing organic chlorophyll and vegetable glycerin to form a first mixture in the container; providing iodized salt to the first mixture to form a second mixture; providing isotonic water to the second mixture to form a third mixture; providing Alfalfa to the third mixture to form a fourth mixture; providing non-iodized kosher salt to the fourth mixture to form a fifth mixture; and providing double distilled water to the fifth mixture to form a sixth mixture.

### CROSS REFERENCE TO RELATED APPLICATION

This non-provisional continuation in part patent application claims priority to U.S. Non-Provisional patent application Ser. No. 17/354,372 filed on Jun. 22, 2021 which is incorporated herein by reference.

### FIELD OF THE INVENTION

The present invention relates to a method for oxygen regenerating a facial mask. More particularly, this invention provides a process for oxygen regenerating a facial mask.

### BACKGROUND OF THE INVENTION

In this new Covid-19 rampant society, the thought of being exposed to this new everchanging virus has been met with the overwhelming fear of being contaminated. Everyone's lives are now consumed with the constant cycle of mandated face protection and sanitizer as the new normal since 2020s' outbreak.

Generally, the public wants to use the traditional standard face mask over the thicker N95 mask to protect against Covid-19, because the standard masks make breathing easier but it does not provide an adequate protection against Covid-19 so it is not an ideal option, whereas N95 or equivalent reusable fabric mask, has the additional drawback of inhibiting the levels of oxygen saturation in the body over prolonged daily use. The inventor, Dr. Serville Waterman has filed a copyright application with the United States Copyrights Office about this subject matter with a Registration Number TXu2-224-320 and effective Registration of Oct. 14, 2020.

Therefore, there is a need for a facial mask that will provide adequate protection against Covid-19 and makes breathing easier.

### SUMMARY OF THE INVENTION

The present invention has been accomplished in view of the above-mentioned technical background, and it is an object of the present invention to provide a method for oxygen regenerating a facial mask.

In a preferred embodiment of the invention, a method for oxygen regenerating a facial mask is disclosed: providing a container; providing organic chlorophyll and vegetable glycerin to form a first mixture in the container; providing iodized salt to the first mixture to form a second mixture; providing isotonic water to the second mixture to form a third mixture; Providing Alfalfa (in the form of Sodium Copper Chlorophyllin) and vegetable glycerin in a container to form the fourth mixture; providing non-iodized kosher salt to the fourth mixture to form the fifth mixture; and providing double distilled water to the fifth mixture to form a sixth mixture.

### BRIEF DESCRIPTION OF THE DRAWINGS

These and other advantages of the present invention will become more apparent as the following description is read in conjunction with the accompanying drawings, wherein:

FIG. 1. shows the chemical formula breakdown of individual components used to make solution/mixture formulas variants for organic oxygen regenerative Solution/Emulsion for the application of the various mask types as aforementioned;

FIG. 2 is a flow chart depicting the step-by-step process of making organic Oxygen regenerative face mask mixture solution formulas variants for face mask types and applications;

FIG. 3 is a display of the quantative unit measurement chart for each of components used in the solution formula variants used for the face mask types and applications;

FIG. 4 is a graphical representation of a (1) one hour study to measure the blood oxygen saturation level by means of an oxygenator to test subjects during controlled physical activity, while wearing an untreated surgical disposable mask, an untreated N95 disposable face mask in comparison to an infused surgical disposable mask in Solution formula III and VI of variants (a, b and c) and infused N95 disposable face mask in the Solution formula III and VI of variants (a, b and c) of a different solution potency;

FIG. 5 is a graphical display of potency of chlorophyll and glycerin in treated infused face mask types over a (6) six months study in a Solution formula III and VI of variants (a, b and c) while in state of dormancy; and

FIG. 6 is a graphical representation (4) four-hour study of the resistance of viral micro particles penetration of untreated face mask as compared to treated infused face mask types in Solution formula III and VI of variants (a, b and c).

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

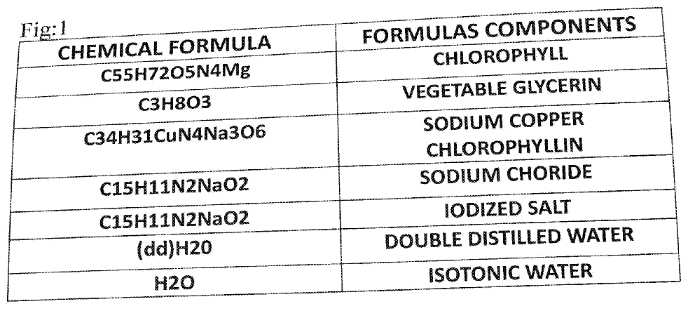

FIG. 1 is the chemical breakdown of individual components used to make solution formulas/mixtures variants for organic oxygen regenerative Solution/Emulsion.

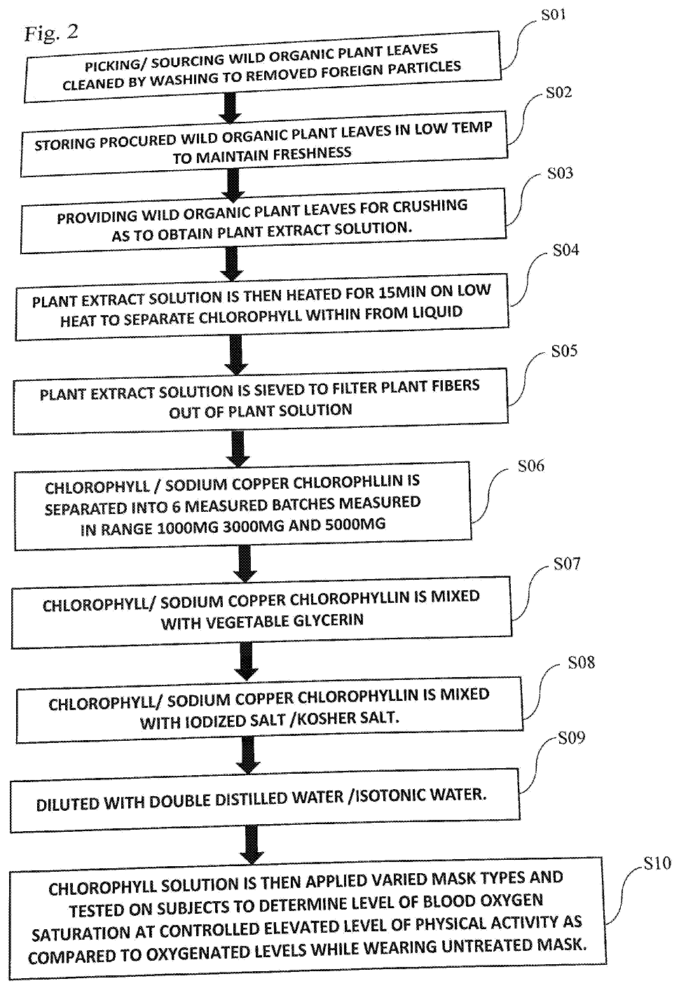

FIG. 2 shows a flow chart depicting the step-by-step process of making an organic oxygen regenerative mask solution formula variant as follows.

Step 1: Picking leaves or sourcing organic/organic wild plant local popular.

Whereas the more favorable leaves were preferred for final testing, using a combination as follows:
Organic wild dandelion
Organic wheatgrass
Organic parsley
Organic wild lavender in equal parts which was cleaned by washing to remove foreign debris

Step 2: The clean leaves were then drip dried in temperature controlled storage.

Step 3: The leaves are then crushed to obtain plant extract Solution.

Step 4: The plant extract Solution is then poured through a fine sieve to separate plant fibers from the organic plant liquid extract into a container.

Step 5: The plant liquid extract is then heated on low temperature for (15) fifteen minutes until plant extract separates to which the organic chlorophyll is skimmed off the top of the plant extract solution.

Step 6: Provide Sodium Copper Chlorophyllin in the form of liquid Alfalfa is measured in (3) three batches in range of 1000 mg: 3000 mg: 5000 mg Provide Chlorophyll obtained in step 5 from organic heat extraction is measured in (3) three batches in range of 1000 mg: 3000 mg: 5000 mg respectively.

Step 7: Provide Vegetable Glycerin in a range of 10 ml: 15 m: 20 ml to (6) six batches of Sodium Copper Chlorophyllin and Organic Chlorophyll respectively and mixed in to improve viscosity to make a first mixture or first solution.

Step 8: Provide 4 oz Isotonic water to (3) three of the batches containing Sodium Copper Chlorophyllin; Provide 4 oz double distilled water to (3) three batches containing Organic Chlorophyll.

Step 9: Provide Kosher Salt in a range of 15 mg: 20 mg: 25 mg to (3) three batches containing Sodium Copper Chlorophyllin respectively.

Provide Iodized Salt in a range of 15 mg: 20 mg: 25 mg to (3) three batches containing Organic Chlorophyll respectively.

Step 10: Provide one (1) disposable surgical face mask and one (1) disposable N95 face mask in each of the (6) six batches and soak for at least two hours of until it is well saturated stirring occasionally to ensure uniform coating of solution III and VI formulas in variant batches (a, b and c) respectively.

Provide test subject to measure Blood Oxygen Saturation levels in body by means of oxygenator in (1) one hour study sessions doing controlled physical activity;

While wearing untreated surgical, N95 disposable mask as compared to Blood Oxygen Saturation levels,

While wearing infused surgical, N95 disposable mask treated in Solution III and VI formulas in variant batches (a, b and c) respectively.

There is also another method of oxygen regenerating a facial mask. The process For oxygen regenerating a facial mask is as follows:

First, providing organic chlorophyll and vegetable glycerin to form the first Mixture/first Solution I. (to increase the viscosity of the solution). Second, providing Iodized salt to the first solution to form Mixture 2/Solution II. Acting in plurality as Natural stabilizer, drying agent and maintain the potency and solution integrity. Third, providing Isotonic water to form Mixture 2/Solution III to form Mixture 3, Forth, Providing in a container and Alfalfa (in the form of Sodium Copper Chlorophyllin) and Vegetable glycerin to form mixture 4, Solution IV. Fifth, providing non-iodized kosher salt to mixture 4/Solution IV to form mixture 5 Solution V. Sixth, providing double distilled water to mixture 5/Solution V to form the Mixture 6/Solution VI. Seventh, providing the disposable surgical facial mask (a) N95 disposable mask (b) to be soaked in Solution III and Solution VI for a plurality of hours to bond with the mask fibers: Solution III and Solution VI can also be applied be means of pressurized spraying as to thoroughly coat mask fibers. Theoretically misting over the outer layer of Reusable fabric mask (c) as to create a virus resistant barrier that can be reapplied after washing.

Eighth, air Drying the facial mask for at least an hour after soaking in the Solution Formula the solution can form a thin film (barrier) over the fibers of the mask: Ninth, testing the facial masks on persons wherein the person breathes and exhales carbon dioxide activating the Chlorophyll in mask over a controlled duration of time with controlled elevated physical activity monitoring the blood oxygen saturation in the subject's body as compared to the blood oxygen saturation levels when wearing untreated facial mask. Lastly, testing the treated facial mask for the movement of micro particles through the various face mask types and defining a more effective resistance to barrier penetration from Covid-19 and airborne Viruses.

FIG. 3 is a display chart of the quantative unit measurement for each element used in Solution III and VI formulas variant (a, b and c) as to infuse surgical, N95 disposable face mask types and even reusable fabric mask.

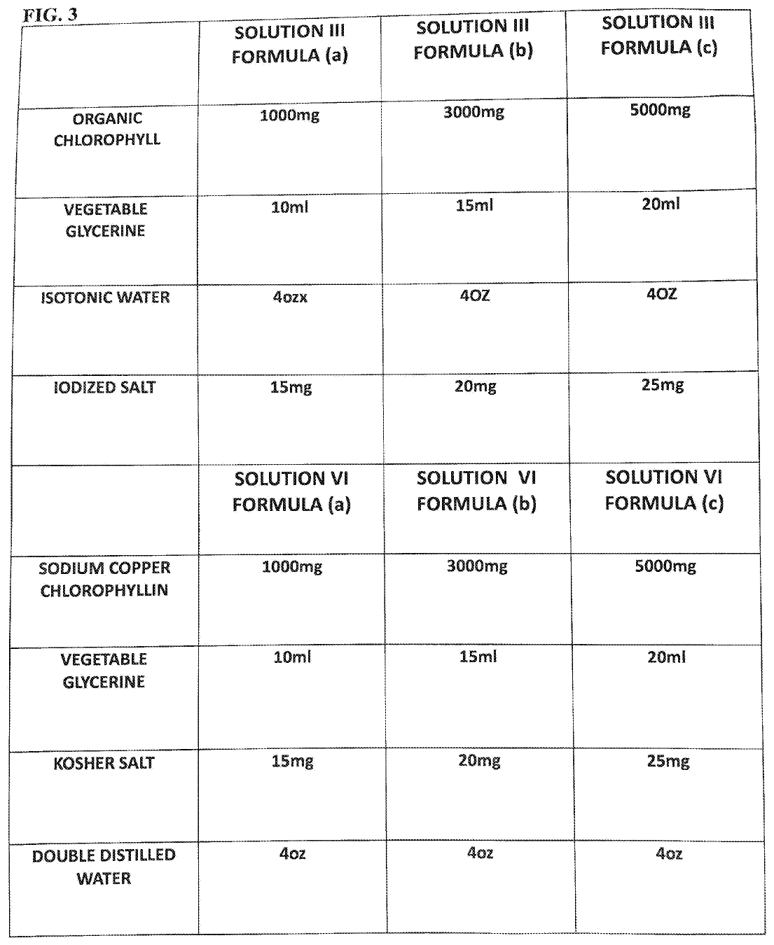

FIG. 4 is a graphical display of the measured blood oxygen saturation level of test subjects during controlled physical activity while wearing the oxygen regenerating face mask of different solution potency, as compared to the measured blood oxygen saturation levels of test subjects wearing the untreated face mask over a (1) one hour study period was as follows:
Untreated surgical disposable mask had a Blood Oxygen Saturation level dropped to 50-60%
Untreated N95 disposable mask had a Blood Oxygen Saturation level at 30-40%
Infused surgical disposable mask with Solution III Formula Variant (a) had a Blood Oxygen Saturation level at 90-100%
Infused N95 disposable mask with Solution VI Formula Variant (a) had a Blood Oxygen Saturation level at 70-80%
Infused surgical disposable mask with Solution III Formula Variant (b) had a Blood Oxygen Saturation level at 90-100%
Infused N95 disposable mask with Solution VI Formula Variant (b) had a Blood Oxygen Saturation level at 90-100%
Infused surgical disposable mask with Solution III Formula Variant (c) had a Blood Oxygen Saturation level at 90-100%
Infused N95 disposable mask with Solution VI Formula Variant (c) had a Blood Oxygen Saturation level at 90-100%

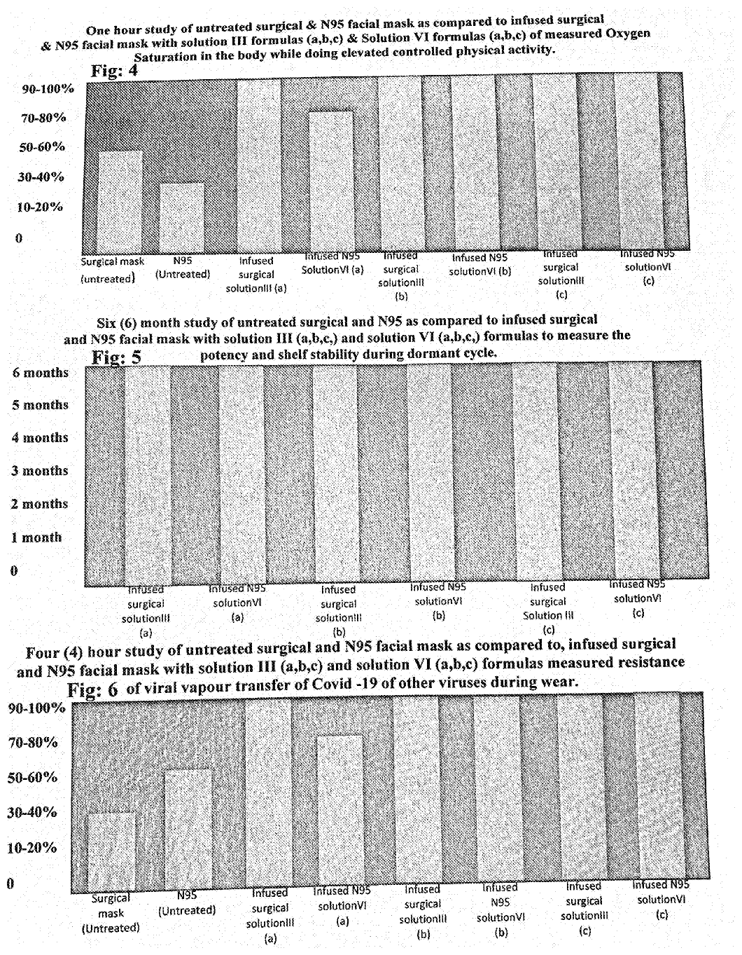

FIG. 5 is a graphical display of potency of chlorophyll and glycerin in treated Infused surgical, N95 disposable face mask as compared over a (6) six-month study in Solution formula III and VI of variants (a, b and c) while in state of dormancy were as follows;
Infused surgical disposable mask with Solution III Formula Variant (a) had a potency of chlorophyll and glycerin-maintained level at 90-100%
Infused N95 disposable mask with Solution VI Formula Variant (a) had a potency of chlorophyll and glycerin-maintained level at 90-100%
Infused surgical disposable mask with Solution III Formula Variant (b) had a potency of chlorophyll and glycerin-maintained level at 90-100%
Infused N95 disposable mask with Solution VI Formula Variant (b) had a potency of chlorophyll and glycerin-maintained level at 90-100%
Infused surgical disposable mask with Solution III Formula Variant (c) had a potency of chlorophyll and glycerin-maintained level at 90-100%
Infused N95 disposable mask with Solution VI Formula Variant (c) had a potency of chlorophyll and glycerin-maintained level at 90-100%

FIG. 6 is a graphical representation (4) four-hour study to of the resistance of viral micro particle penetration of untreated face mask as compared to treated infused face mask types in Solution formula III and VI of variants (a, b and c) are as follows;
Untreated surgical disposable mask had a viral micro particle penetration resistance at a rate of 30-40%
Untreated N95 disposable mask had a viral micro particle penetration resistance at a rate of 60-70%
Infused surgical disposable mask with Solution III Formula Variant (a) had a viral micro particle penetration resistance at a rate of 90-100%
Infused N95 disposable mask with Solution VI Formula Variant (a) had a viral micro particle penetration resistance at a rate of 70-80%
Infused surgical disposable mask with Solution III Formula Variant (b) had a viral micro particle penetration resistance at a rate of 90-100%
Infused N95 disposable mask with Solution VI Formula Variant (b) had a viral micro particle penetration resistance at a rate of 90-100%
Infused surgical disposable mask with Solution III Formula Variant (c) had a viral micro particle penetration resistance at a rate of 90-100%
Infused N95 disposable mask with Solution VI Formula Variant (c) had a viral micro particle penetration resistance at a rate of 90-100%

This invention provides a method to oxygen regenerate any type of facial mask. By utilizing this method of oxygen regeneration for a facial mask a person will be able to breathe in clean Oxygen while also providing an adequate protection against Covid-19 and other airborne viruses. This method increases the level of oxygen saturation in the body over prolonged daily use instead of inhibiting the levels of oxygen saturation displayed in facial mask that does not undergo this process.

Although the present invention has been described above in terms of specific embodiments, many modifications and variations of this invention can be made as will be obvious to those of ordinary skill in the art, without departing from its spirit and scope as set forth in the following claims.

What is claimed is:

1. A method for oxygen regenerating a facial mask comprising;
providing sterile containers;
providing organic chlorophyll and vegetable glycerin to form a first mixture in the container;
providing iodized salt to the first mixture to form a second mixture;
providing isotonic water to the second mixture to form a third mixture;
providing Alfalfa (in the form of Sodium Copper Chlorophyllin) and vegetable glycerin in a sterile container to form a fourth mixture;
providing non-iodized kosher salt to the fourth mixture to form a fifth mixture; and providing double distilled water to the fifth mixture to form a sixth mixture.

2. The method of claim 1, providing a disposable surgical facial mask N95 disposable mask to be soaked in mixture 2 and mixture 6 for a plurality of hours to bond with mask fibers of the disposable surgical facial mask N95.

3. The method of claim 2, further comprising applying pressurized spray to the mixture 3 and mixture 6 to thoroughly coat the mask fibers of the disposable surgical facial mask N95.

4. The method of claim 3, further comprising air drying the disposable surgical facial mask N95 for at least an hour after soaking the disposable surgical facial mask N95 in the sixth mixture that can form a thin film (barrier) over a plurality of fibers of the disposable surgical facial mask N95.

5. The method of claim 4 further comprising testing the disposable surgical facial mask N95 on a person wherein the person breathes and exhales carbon dioxide activating the Chlorophyll in the disposable surgical facial mask N95 over a controlled duration of time with controlled elevated physical activity monitoring the blood oxygen saturation in the subject's body as compared to the blood oxygen saturation levels when wearing an untreated facial mask.

6. The method of claim 5, further comprising testing the treated disposable surgical facial mask N95 for the movement of micro particles through a plurality of various face mask types and defining a more effective resistance to barrier penetration 25 from Covid-19 and airborne Viruses.
